(19) United States
(12) Patent Application Publication
(10) Pub. No.: US 2003/0046163 A1
(43) Pub. Date: Mar. 6, 2003

(54) Method of creating award-based incentive programs

(76) Inventors: Clarkson Carpenter III, St. Louis, MO (US); David Charles Wisland, St Louis, MO (US)

Correspondence Address: Bryan K. Wheelock, Harness, Dickey & Plerce, P.L.C., Suite 400, 7700 Bonhomme Avenue, St. Louis, MO, 63105, US

(21) Appl. No.: 10/190,332

(22) Filed: Jul. 3, 2002

Related U.S. Application Data
(60) Provisional application No. 60/303,050, filed on Jul. 5, 2001.

(51) Int. Cl. G06F 17/60

(52) U.S. Cl. 705/14

(57) ABSTRACT

A method of creating a customized award-based incentive program to improve performance of at least one program participant includes: displaying a plurality of industries to the user; in response to the selection by the user of a particular industry from the displayed plurality of industries, displaying a plurality of focus areas for the selected industry; in response to the selection by the user of a particular focus area from the displayed focus areas, displaying a plurality of objectives for the selected focus area; in response to the selection of a particular objective, displaying a plurality of program intensity options in the form of text descriptions of market conditions, and accepting a selection of program intensity; allowing the user to select team or individual award-earning mode; cueing the user to input demographic information about the program participants, and accepting the input budget information and demographic information; and displaying to the user the rules structure for at least one recommended award-based incentive program based upon the selections and input of the user.

### CROSS-REFERENCE TO RELATED APPLICATION

This application claims priority of prior Provisional Application Serial No. 60/303,050, filed Jul. 5, 2001, the disclosure of which is incorporated herein by reference.

### FIELD OF THE INVENTION

This invention relates to award-based incentive programs, also known as recognition programs or performance improvement programs, and in particular to a method of developing award-based incentive programs

### BACKGROUND OF THE INVENTION

Award-based incentive programs are used to improve the overall performance of various organizations. The effectiveness of an award-based incentive program depends upon its design. Prior to the present invention, the design of an award-based incentive program required extensive and expensive consultation from experienced program designers. Factors such as the type of industry, the objective of the program, budget, and the intensity of the program-related business environment must be assessed and considered.

### SUMMARY OF THE INVENTION

The present invention provides a method for the automated creation of an effective, customized award-based incentive program to improve performance of at least one program participant. Generally this method comprises (1) displaying a plurality of industries to the user, (2) in response to the selection by the user of a particular industry from the displayed plurality of industries, displaying a plurality of focus areas for the selected industry; (3) In response to the selection by the user of a particular focus area from the displayed focus areas, displaying a plurality of objectives for the selected focus area; (4) In response to the selection by the user of a particular objective, displaying a plurality of program intensity options in the form of text descriptions of market conditions; (5) Accepting a selection of program intensity; (6) Allowing the user to select team or individual award-earning mode; (7) Cueing the user to input demographic information about the program participants, (8) Accepting the input budget information and demographic information; and (9) displaying to the user at least one recommended award-based incentive program based upon the selections and input of the user. According to one embodiment the user is prompted to either input a budget or elect to have the system recommend the most effective budget.

Thus a user is able to create a customized award-based incentive program from a plurality of program templates, by making a plurality of selections from displayed selections. The resulting program is customized to a particular industry, focus area, and objective. Further the resulting program is customized to a budget input by the user, or derived from the participant's incomes and the intensity of the program related business environment. Finally, the resulting program, and particularly the program theme and incentive awards, is targeted to the particular demographics of the participants. The entire system can be implemented by software operating on the user's computer, or via the Internet.

These and other features and advantages will be in part apparent and in part pointed out hereinafter.

### BRIEF DESCRITION OF THE DRAWINGS

FIG. 1 is a flow chart of the method of developing an incentive program according to the principles of this invention;

FIG. 2A is a schematic view of an industry-selection screen for a automated incentive program development program constructed according to the principles of this invention;

FIG. 2B is a chart showing possible focus areas available for each of the industry selections available under the screen shown in FIG. 1A;

FIG. 3 is a schematic diagram, showing possible incentive program objectives for a particular industry and focus area and illustrating other user inputs for customizing the incentive program;

FIG. 4 is a diagram of a thematically appropriate graphical user interface for a selected industry and focus area;

FIG. 5 is a is a schematic diagram showing the effect of objective selection on the creation of a customized incentive program from a plurality of predetermined program templates;

FIG. 6 is a schematic diagram showing the effect of award-earning mode selection on the creation of a customized incentive program from a plurality of predetermined program templates;

FIG. 7 is a schematic diagram showing the effect of the program intensity on the creation of a customized incentive program from a plurality of predetermined program templates;

FIG. 8 is a schematic diagram of an arrangement of program templates;

FIG. 9 is a schematic diagram showing the effect of the budget mode selection;

FIG. 10 is a schematic diagram showing the entry of demographic information; and

FIG. 11 is a schematic diagram illustrating one way of implementing user adjustment of the budget and time frame for the recommended program.

Corresponding reference numerals indicate corresponding parts throughout the several views of the drawings.

### DETAILED DESCRIPTION OF THE PREFERRED EMBODIMENT

The present invention relates to an automated method of developing an incentive program, that can be implemented on a computer. The method is conveniently implemented by software, which displays information, for example on a computer monitor, and allows the user to make selections and input information, for example using a conventional keyboard and mouse, or other input devices, such as touch screen displays. More specifically, the system can be implemented via the Internet, in which case the user would go to a particular website, and the software on the server would implement the method, and display information to, and receive input from, the user's computer. Alternatively, or in addition, the software could be downloaded onto the user's computer via the Internet, or from media such as diskettes, CD's, or DVD's.

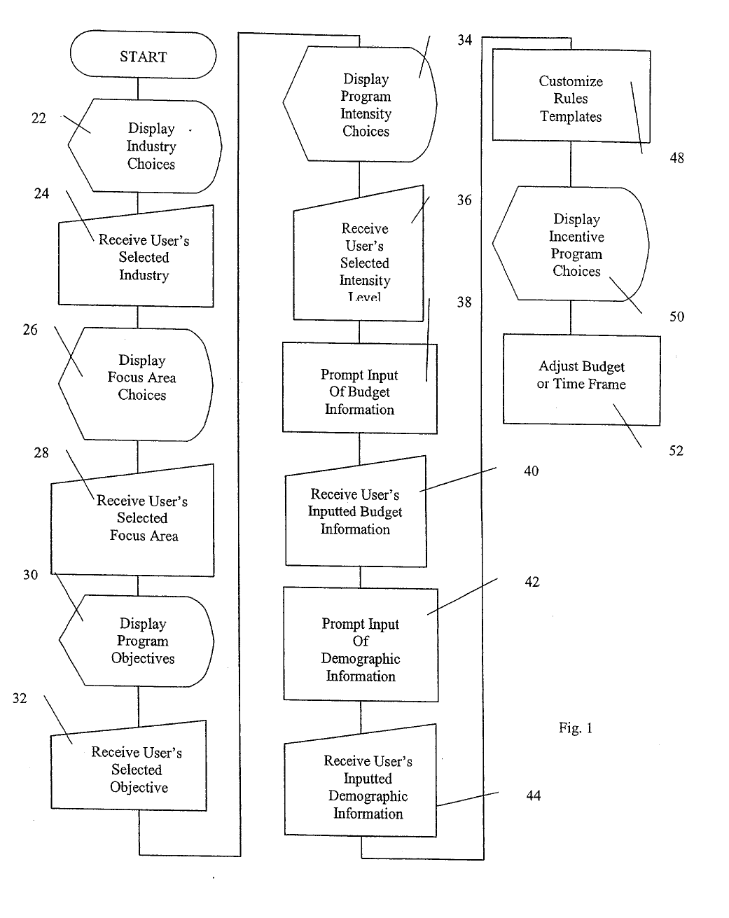

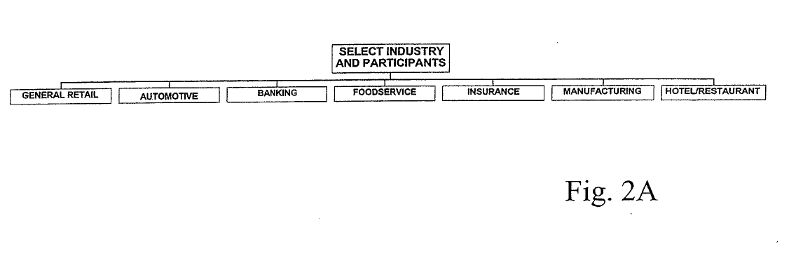

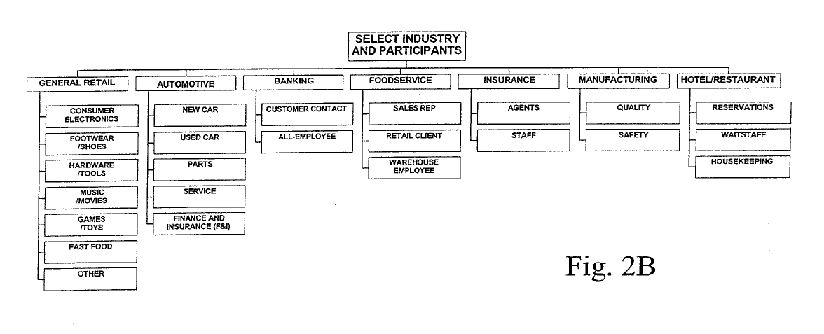

In the preferred embodiment the method is adapted to automatically operate to develop customized incentive programs in any of a variety of industries. At step 22 in FIG. 1, the system implementing the method of this invention displays a plurality of industries from which the user can select the most appropriate industry. This is illustrated in FIG. 2A. As shown in FIG. 2A, these industries might include: GENERAL RETAIL, AUTOMOTIVE, BANKING, FOODSERVICE, INSURANCE, MANUFACTURING, and HOTEL/RESTAURANT. Of course, the system could display additional, fewer, or different industries from which the user can select. At 24, the user inputs a selection of the industry. The user makes a selection for example by pointing and clicking with a mouse, keying in a selection, or operating a touch screen display. Of course, the system could be set up to implement the method in a single industry, in which case the display step 22 and the input step 24 could be eliminated or by-passed.

At step 26, the system implementing the method of this invention displays a plurality of focus areas for the particular industry that the user selected. This is illustrated in FIG. 2B, where a plurality of focus areas are indicated for each industry. All of the industries and focus areas could be displayed to the user at one time, similar to FIG. 2B, or just the focus areas relating to the industry selected by the user can be displayed. The display and selection of a focus area allows the user to customize the incentive program even further. As shown in FIG. 2B, under the GENERAL RETAIL industry, the following focus areas could be displayed: CONSUMER ELECTRONICS, HARDWARE/TOOLS, MUSIC/MOVIES, GAMES/TOYS, FAST FOOD, and OTHER; under the AUTOMOTIVE industry, the following focus areas could be displayed: NEW CAR, USED CAR, PARTS, SERVICE, FINANCE AND INSURANCE (F&I); under the BANKING industry, the following focus areas could be displayed: CUSTOMER CONTACT and ALL-EMPLOYEE; under FOOD SERVICE industry, the following focus areas could be displayed SALES REP, RETAIL CLIENT, WAREHOUSE EMPLOYEE; under INSURANCE industry, the following focus areas could be displayed: AGENTS and STAFF; under the MANUFACTURING industry, the following focus areas could be displayed: QUALITY and SAFETY; and under HOTEL/RESTAURANT industry, the following focus areas could be displayed: RESERVATIONS and HOUSEKEEPING. Of course, the system could display additional, fewer, or different focus areas. At 28 the user selects a focus area. The user makes a selection for example by pointing and clicking with a mouse, keying in a selection, or operating a touch screen display. Of course, the system could be set up to implement the method in a single focus area, in which case the display step 26 and the input step 28 could be eliminated or by-passed.

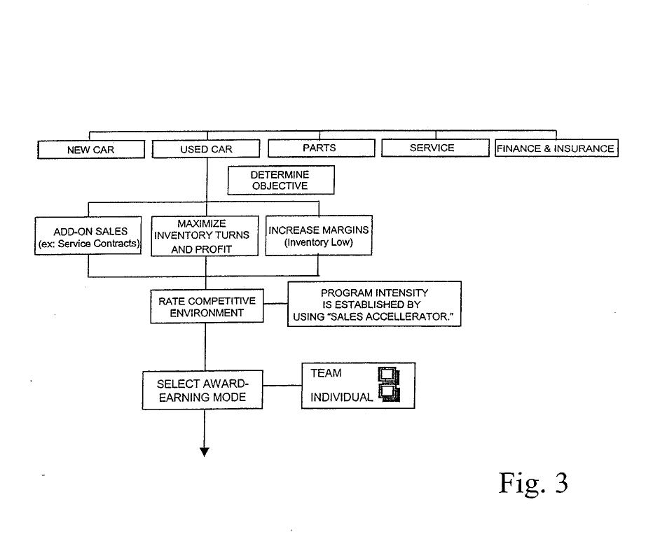

Once the industry and/or focus area have been specified, either by default or by the selections of the user, the system prompts the user to select the objective of the incentive program. These objectives are preferably customized to the specified industry and focus area. Preferably there are at least 3 or 4 standard objectives for each industry and focus area. When the Sales Manager selects a subset of a particular industry (example: USED CAR), the system will pull up three possible program objectives (see FIG. 2). At 30 the system implementing the method of this invention displays one or more incentive program objectives appropriate to the specified industry and focus area. For example, as shown in FIG. 3, if the user selected the AUTOMOTIVE industry, and the USED CAR focus area, the development program might display three program objectives: ADD-ON SALES, MAXIMIZE INVENTORY TURNS, and INCREASE MARGINS. The system implementing the method might display additional cueing information to help the user make a selection. Of course fewer or additional objectives, or different objectives can be displayed. The objectives displayed for the other industries and focus areas are preferably appropriate to the particular industry and focus area. At 32 the user selects the incentive program objective. The user makes a selection for example by pointing and clicking with a mouse, keying in a selection, or operating a touch screen display. Of course, the system could be set up to implement the method with a single objective for a particular industry and focus area, in which case the display step 30 and the input step 32 could be eliminated or by-passed.

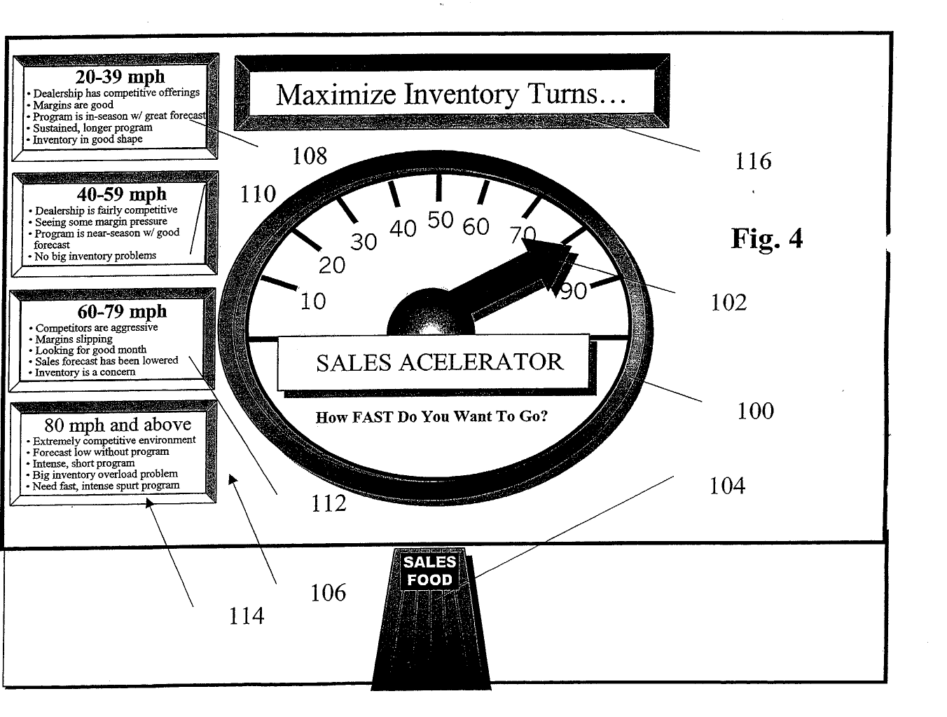

After the user selects the program objective, at step 34 the system implementing the method prompts the user to specify the program-related business environment, by displaying one or more intensity options. This can be conveniently done with a graphical user interface. Preferably the graphical user interface thematically relates to the particular industry/focus area that have been specified by the user. For example, as shown in FIG. 4, if the user selected the AUTOMOTIVE industry, and the USED CAR focus area, the development program might display a screen with a “sales accelerator” resembling an automobile speedometer and accelerator pedal control, which is thematically appropriate to the selected industry and focus area. The “sales accelerator” graphical user interface includes speedometer 100, with an indicator 102, to visually communicate to the user the concept of relative intensity of the selection, and an accelerator pedal 104 that the user can operate to physically communicate to the user the concept of relative intensity. At step 36 the system implementing the method receives the user's input of desired intensity. For example, as shown in FIG. 4, the user can operate the pedal 104 (for example by pointing and clicking a mouse) to increase and decrease the speed. Preferably text displays 106 are incorporated into the graphical user interface to help the user make the appropriate selection. These text displays include statements describing different competitive environments. The user makes the appropriate selection, by selecting the range that most closely represents the user's perception of the industry. For example, as shown in FIG. 4, a window 108 describes the 20-39 MPH range as: “Dealership has competitive offerings”, “Margins are good”, “Program is in-season, with great forecasts”, and “Inventory in good shape”. A window 110 describes the 40-59 MPH range as: “Dealership is fairly competitive”, “Seeing some margin pressure” Program is near-season, with good forecast”, and “No big inventory problems”. A window 112 describes the 60-79 MPH range as: “Competitors are aggressive”, “Margins are slipping”, “Looking for good month”, and “Inventory is a concern”. A window 114 describes the 80 and above MPH range as: “Extremely competitive environment”, “Forecast is low without program”, “Intense, short program”, “Big inventory overload problem”, and “Need fast, intense spurt program”. The window 108, 110, 112 or 114 corresponding to the selected intensity can be highlight to indicate to the user the selected intensity level. A window 116 can further be provided to display the selected objective, to remind the user.

The particular intensity levels, and more particularly the descriptions for each of the levels in the windows 108, 110, 112, and 114, depend upon the user's selection of industry, focus area, and objective. The appearance and operation of the graphical user interface preferably depends at least upon the selected industry, more preferably the selected industry and focus area, and most preferably the selected industry, focus area, and objective.

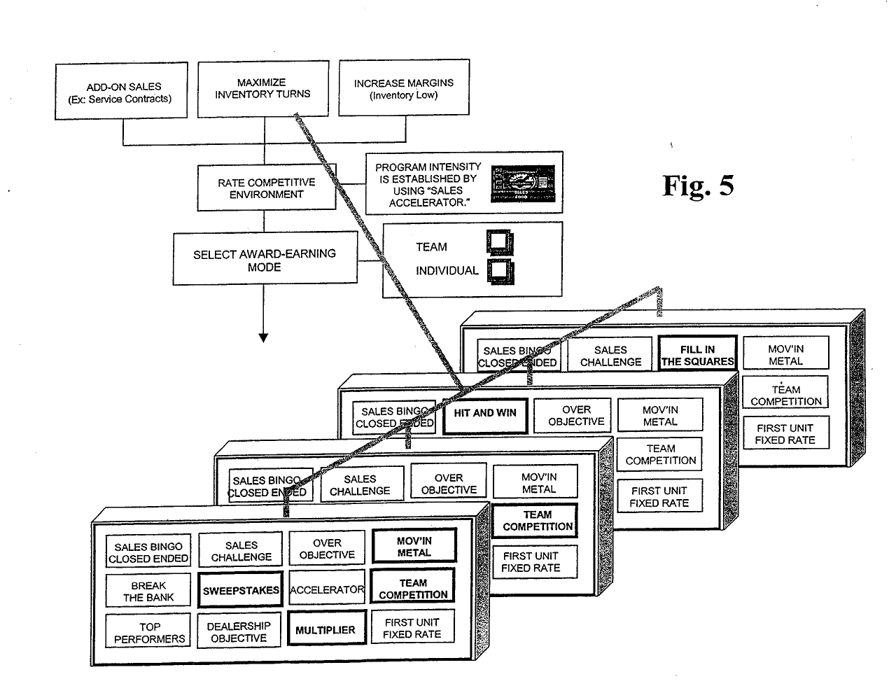

After the selection of the program intensity in steps 34 and 36, the system implementing the method prompts the user to specify the award-earning mode. As shown in FIG. 5, this can be on a team basis or an individual basis. The user can make the selection, for example by pointing and clicking a mouse, keying in a selection, or operating a touch screen. Alternatively this step can be eliminated, and the system implementing the method can be designed to automatically create an incentive program for a particular type of environment, for example an individual environment.

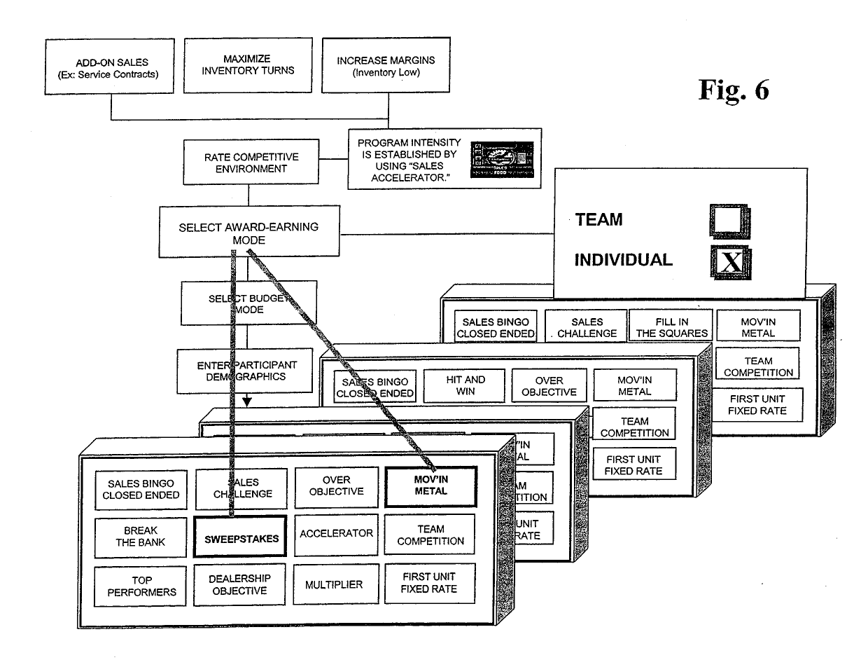

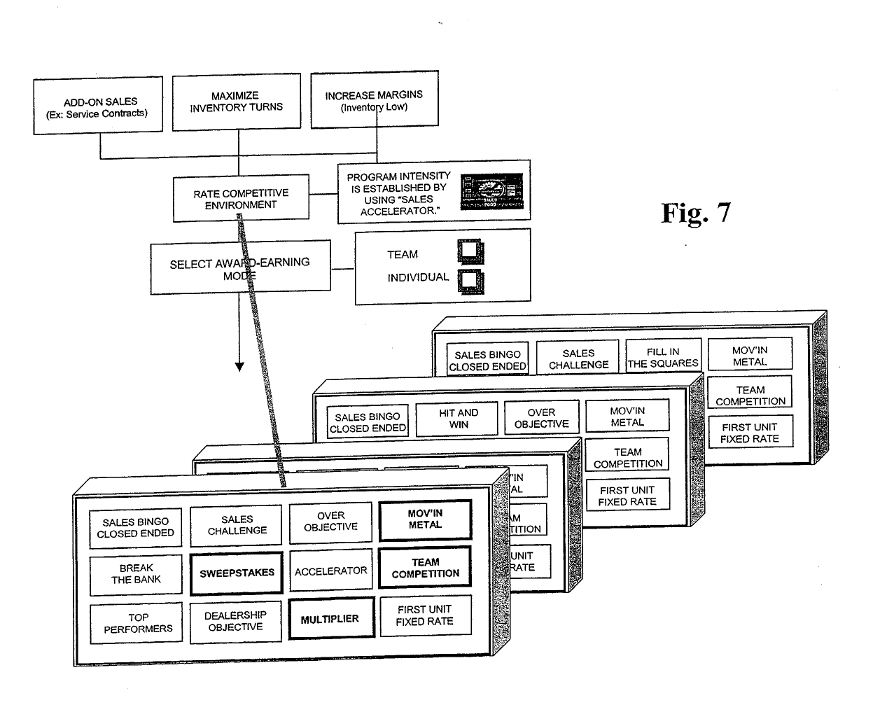

As illustrated schematically in FIG. 6, and described and illustrated in more detail below, the method employs a plurality of program rules templates for a wide variety of incentive programs. The user's selection of a particular objective, filters out some of the possible rules templates, leaving those appropriate to the user's selection of industry, focus area, objective, and/or budget. In this preferred embodiment there are forty-eight such templates, arranged in four levels of twelve templates. The templates in each level can be similar, as shown in FIG. 6, differing primarily in intensity, or the templates can vary from intensity level to intensity level. The system implementing the method selects or filters from the collection of predetermined program templates, the templates most appropriate for the particular selections made by the user. Thus, for example the user's selection of the AUTOMOBILE industry, and the USED CAR focus area resulted in the identification of 48 potential program templates, each designed to be applicable to the industry and focus area. When the user selects a particular objective, some of these preselected templates are eliminated, leaving those most appropriate to the user's selected objective. Preferably, at least one program template is left for each intensity level. Otherwise, the program preferably adjusts the available intensity levels displayed for the selected industry and focus area, so that the user cannot select an objective for which there is not at least one program template. Thus, at step 32, when the user selected an objective, for example “maximize inventory turns” as shown in FIG. 6, some of the program templates are filtered out, leaving a few program templates 120 at each intensity level. Then, at step 36, when the user selected an intensity level, some of the templates are filtered out, leaving just the templates appropriate for the selected objective, at the selected intensity level. These are illustrated as the four bold rules structures in the lowest intensity level in FIG. 7.

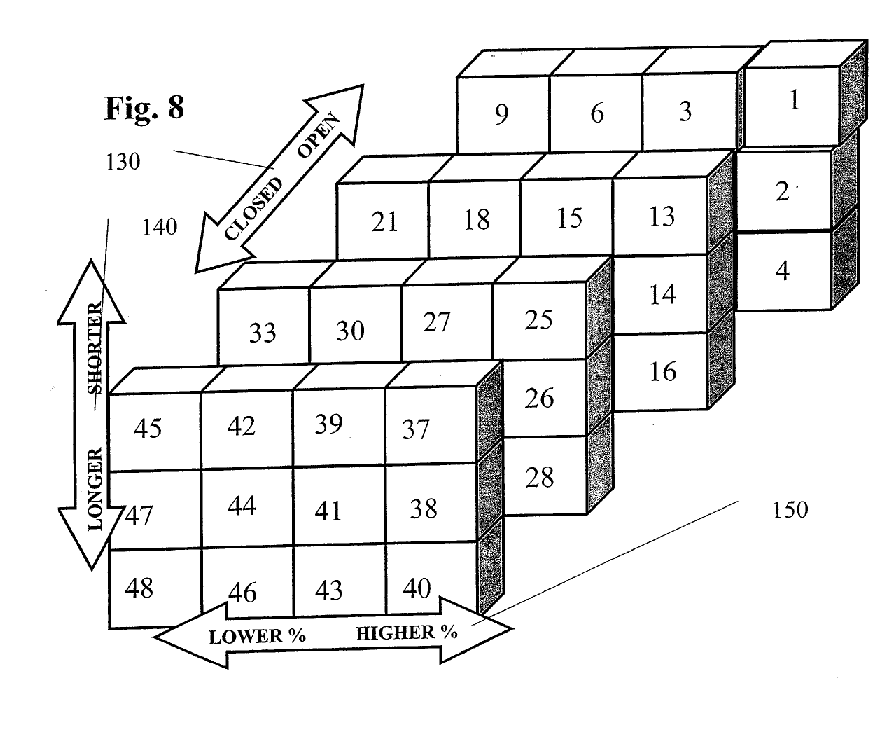

In the preferred embodiment of this invention, three key variables of intensity of the incentive program are openness of the rules, duration of the program, and the percentage payout. Of course other variables for the intensity of the program could be used. A possible arrangement of the 48 program templates according to inventive program intensity is shown in FIG. 8. As shown in FIG. 8, the program templates can be considered to be arranged in a three-dimensional array with program templates 1 through 48 in order of decreasing intensity.

The openness of the rules structure is one variable of the intensity of an incentive program. An open rules structure is one without a fixed budget, which encourages participants to sell as much as they can within the time constraints of the incentive program. Thus the more open the rules structure—the more intense the incentive program, and the more closed the rules structure—the less intense the incentive program. Thus the program templates increase and decrease in intensity in the directions indicated by double-headed arrow 130 in FIG. 8. The duration of the program is another variable of the intensity of an incentive program. The shorter the duration, the more intense the program, and the longer the program the less intensive the incentive program. Thus the program templates increase and decrease in intensity in the directions indicated by double-headed arrow 140. The payout percentage is still another variable of the intensity of the incentive program. The greater the percentage of the payout relative to the participant's total compensation, the greater the intensity, and the smaller the percentage of the payout relative to the participant's total compensation, the less intensive. Thus the program templates increase and decrease in intensity in the directions indicated by double-headed arrow 150.

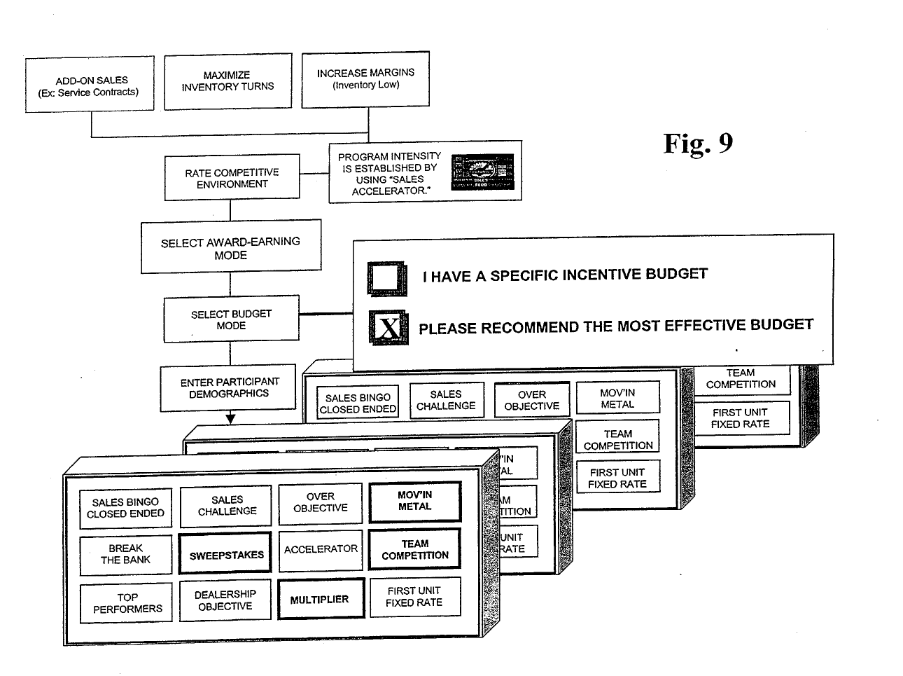

The system implements the method of this invention then prompts the user to input selected information about the program and participants, including for example, budget information, including the amount available for the program, and the compensation of the participants in the program, and information about the age and gender of the participants, and possible additional information about their hobbies and interests. At 38 the system prompts the user to input a program budget, and at 40 the system receives the user's input budget. As shown in FIG. 9, the system preferably gives the user the option to input a specific incentive budget, or to allow the system to make a recommendation of the most effective budget given the selections and inputs made by the user.

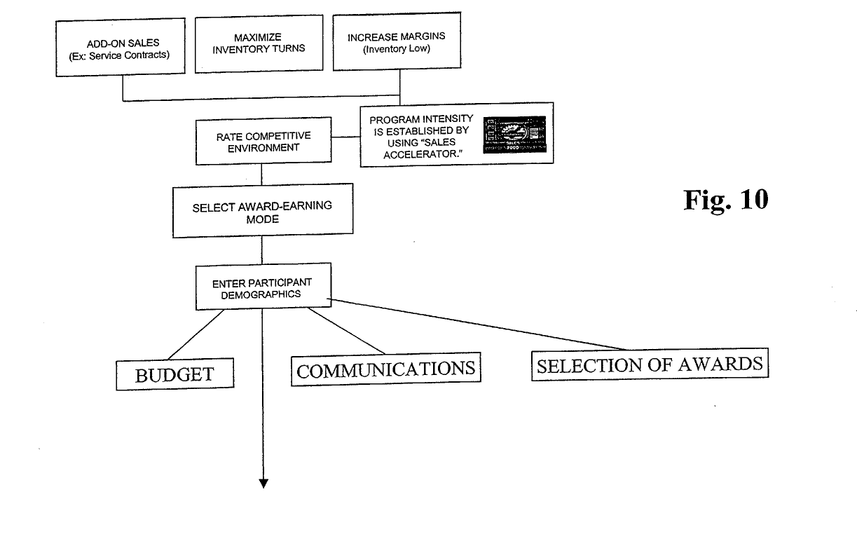

At 42 the system prompts the user to input demographic information, and at 44 the system accepts user's input. This is illustrated schematically in FIG. 10. The budget information, which includes information about the participant's current income, is used to help determine the most effective rules structure and awards. The awards are preferably targeted to be a certain percentage of the participant's average income. The personal demographic information is used to determine the appropriate theme for the incentive program, and to select more appropriate awards.

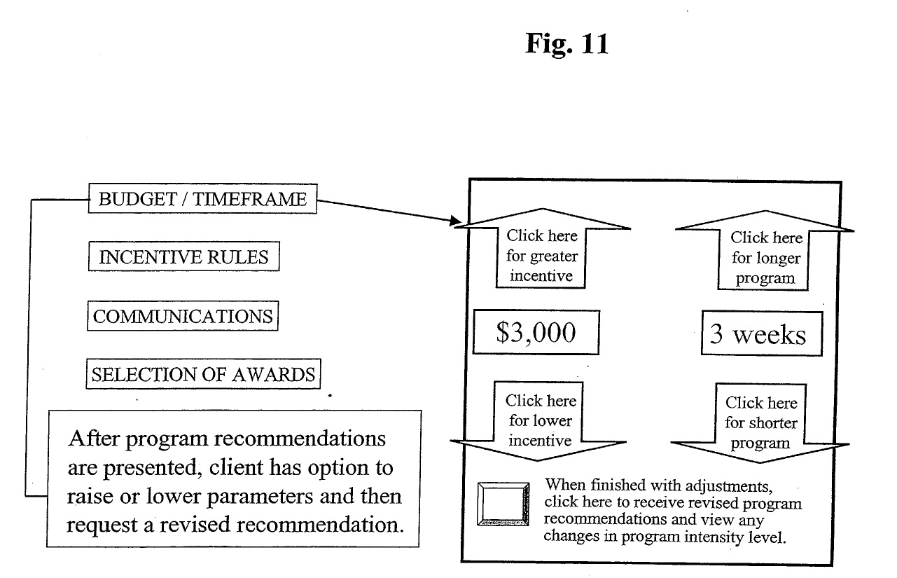

At 48 the development program customizes the rules templates that have been filtered with the user's sections, and adapts them to the budget and demographics of the participants, and at 50 displays on or more programs for the user's review. The programs preferably include a recommended budget, rules structure, communications (with the program participants), and a selection of incentive awards. If the budget selected by the user is insufficient to fund an effective incentive program, the program alerts the user, and guides the user to either increase the budget, or allows the user to go back and adjust by reducing the intensity of the program, including a recommended budget. The development system can simultaneously display the program budget so that the user can see the effect of intensity on the incentive program budget. At 52 the development program prompts the user to adjust the program, for example by increasing the budget to achieve the objectives, or by changing the duration and/or program intensity to stay within the budget. This is illustrated schematically in FIG. 11, where the system can graphically display a budget and a time frame, and the user can increase or decrease the budget and/or increase or decrease the time frame. However, budget and time frame and not independent, thus for example, decreasing the budget may cause the system to automatically decrease the time frame to ensure that the program remains effective. Similarly, increasing the budget may cause the system to increase the time frame, so that program efficiently uses budgeted funds. Likewise, decreasing the time frame may cause the system to automatically decrease the budget, so that the program efficiently uses budgeted funds, and increasing the time frame may automatically increase the budget so that the program remains effective. Increases and decreases in the budget and time frame will preferably also affect other parameters of the programs so that the user is given maximum flexibility in imposing selections on budget on the program: The system automatically adjusts the rules to accommodate the user's selections.

The system preferably includes a database of possible combinations of program length and award payout for each possible combination of industry, focus area, and objective. This database is preferably grouped into levels of intensity; there are 4 major levels of intensity in this preferred embodiment. Each level has a dozen or so possible combinations of program length and award rate. (See FIGS. 6-7). Each level of intensity corresponds to a “competitive scenario” that the user selects as the level of challenge that their business situation resembles most. (See FIG. 4). Once this is selected and combined with the “Team or Individual” choice, the system will recommend a program design that will have a rough budget, rules, suggested timeframe and communications. The budget initially is a factor of how many participants are in the program, their average income and how competitive the Sales Manager perceives the climate to be.

Operation

In operation, as illustrated in FIGS. 2A and 2B, the system displays for the user a selection menu of sales incentive programs that the customer can choose from, allowing for an immediate focus on that particular industry and choice of focus areas within that industry. For instance, if user was interested in building a sales incentive program in one of the listed industries, say the automotive industry, the additional focus areas would be: New Car, Used Car, Parts, Service, Finance and Insurance. These are main parts of a retail automotive business; other segments (like the Body Shop or Secretarial/General Staff) could be added to the program later or might be addressed by the customer using the generic program choice.

If, for example, the customer chooses “Used Car,” the system automatically searches a database and as illustrated in FIG. 3, provides the following choices of sales objectives for a used car lot: Add-on sales, Maximize inventory turns, and Increase margins. If “New Car” had been selected, the objectives offered by the system would be different, and may include choices like: Customer Satisfaction Index, Average Accessory Sales, Close Ratio and Average Margin.

Once an objective is selected, the system searches a database of predesigned rules structures that might fit that particular objective. (See FIG. 5) These are preferably not yet revealed to the operator, but are held for further filtering based on additional input. To collect this input, the system next offers a tool that is customized for each industry. In this particular example, it is designed as an accelerator and dashboard (see FIG. 4). The function of this tool is to allow for the simultaneous gathering of nonnumeric or intangible information about the user's perception of the competitive situation and general urgency for an incentive program. Just like the analogy of an automobile, the system will get a sense for the immediate driving conditions. The approach of a hill, or a need to pass another car will help determine how much fuel will be needed and will reveal the timeframe in which it will be consumed.

As the user moves the dial on the speedometer, a box to the left is highlighted which provides a descriptive situational analogy that approximately matches the program “intensity” required or perceived by the user (See FIG. 4). In the example provided, the sales manager “pushed” the speedometer to over 80, indicating that their situation is extremely competitive and/or urgent, and they were willing to invest appropriately to get quick results.

The general program rules are then displayed and an award level assumption for an average participant (used car salesperson) is displayed. The user can adjust the average annual income by selecting a choice of ranges provided. The effect of this selection will increase or decrease the awards payout. These “dial-ups” allow a manager to easily enact various “what if” scenarios that help match the program to the local situation, timeframe or budget. These decisions are made by the user, using local experience and custom, and indicating the choice by placing a checkmark in a box. (See FIG. 6). If the workforce is divided into work teams that compete naturally, then some additional motivation can be added by working with these groupings to employ the existing competitive spirit. If no established teams exist, they may be designed for the program, using whatever grouping is deemed appropriate by the user. The system can provide prompts to assist the user, consisting of suggestions to ensure a fair competition, such as picking “captains” who will then choose teams or using sales volume as a determinant to help divide the group fairly.

The automatically suggested “format” or “game” is pre-determined earlier when the user selects the intensity required. For example, for the most intense levels, a “break the bank” format may be used, for the median level, a simple sell that get this structure is used, and for the “easy sell,” lower-intensity level, a “bingo” game is used to create and sustain interest in a longer and lower payout format.

The format for other types of participants (like New Car Sales) may have some overlap, but will have some new games, structures and creative communications solutions that are appropriate for the particular sales environment.

Thus the method and system of the present invention allow a user without experience in the field of designing award-based incentive programs, to design an award-based that is effective and efficient. The users can develop an effective performance improvement program rule structure that matches the needs of their particular business and current environment.

1. A method of creating a customized award-based incentive program to improve performance of at least one program participant, the method comprising:
displaying a plurality of industries to the user;
in response to the selection by the user of a particular industry from the displayed plurality of industries, displaying a plurality of focus areas for the selected industry;
in response to the selection by the user of a particular focus area from the displayed program objectives, displaying a plurality of objectives for the selected program focus area;
in response to the selection by the user of a particular objective, displaying a plurality of program intensity options in the form of text descriptions of market conditions, and accepting a selection of program intensity;
allowing the user to select team or individual award-earning mode;
cueing the user to input demographic information about the program participants, and accepting the input budget information and demographic information; and
displaying to the user the rules structure for at least one recommended award-based incentive program based upon the selections and input of the user.

2. The method according to claim 1 wherein each displayed rules structure includes a display of the recommended budget and the recommended time frame, and wherein the user can increase or decrease at least one of the budget and time frame, and wherein the rules structure is updated or changed in response to the adjustment.

3. The method according to claim 1 wherein the step of displaying a plurality of program intensity options, includes displaying a graphic showing level of intensity, in a theme related to the industry selected by the user.

4. The method according to claim 1 wherein the displays are made on the display device of the user's computer.

5. The method according to claim 1 wherein the displays transmitted to the user and the users selections and input are transmitted transmitted via the Internet.

6. A method of creating a customized award-based incentive program to improve performance of at least one program participant, the method comprising:
displaying a plurality of industries to the user;
in response to the selection by the user of a particular industry from the displayed plurality of industries, displaying a plurality of focus areas for the selected industry;
in response to the selection by the user of a particular focus area from the displayed focus areas, displaying a plurality of objectives for the selected focus area;
in response to the selection of a particular program objective from the displayed objectives, displaying a plurality of program intensity options in the form of text descriptions of market conditions, and accepting a selection of program intensity;
allowing the user to select team or individual award-earning mode;
cueing the user to input demographic information about the program participants, and accepting the input budget information and demographic information;
displaying to the user the rules structure for at least one recommended award-based incentive program based upon the selections and input of the user, each award-based incentive program including a display of the recommended budget and time frame for the program,
allowing the user to increase or decrease the budget and/or time frame, and updating the rules structure, budget, and time frame, and/or change the at least one recommended award-based incentive program.

7. The method according to claim 6 wherein there are a plurality of predetermined program rules, and the step of displaying to the user the rules structure for at least one recommended award-based incentive program based upon the selections and input of the user, comprises selecting among the predetermined program rules, and customizing those rules based upon the user input.

8. A method of selecting among a plurality of predetermined incentive program rules structures and customizing the selected rules structures, to the needs of a particular user, the method comprising the steps of:
displaying a plurality of industries to the user;
in response to the selection by the user of a particular industry from the displayed plurality of industries, displaying a plurality of focus areas for the selected industry;
in response to the selection by the user of a particular focus area from the displayed focus areas, displaying a plurality of objectives for the selected focus area;
in response to the selection of a particular objective from the displayed objectives, displaying a plurality of program intensity options in the form of text descriptions of market conditions, and accepting a selection of program intensity;
allowing the user to select team or individual award-earning mode;
cueing the user to input demographic information about the program participants, and accepting the input budget information and demographic information;
selecting among the plurality of predetermined programs based upon the selections made by the user and the demographic information made by the user, and displaying to the user the rules structure for at least one recommended predetermined award-based incentive with the rules customized according to the demographic information input by user, each award-based incentive program including a display of the recommended budget and time frame for the program,
allowing the user to increase or decrease the budget and/or time frame, and updating the rules structure, budget, and time frame, and/or change the at least one recommended award-based incentive program.
